(19) United States
(12) Patent Application Publication
(10) Pub. No.: US 2024/0100820 A1
(43) Pub. Date: Mar. 28, 2024

(54) Lithographic Printing Press Make-Ready Method

(71) Applicant: AGFA Offset BV, Mortsel (BE)

(72) Inventors: Thomas Billiet, Mortsel (BE); Willem Cortens, Mortsel (BE); Yves Defossez, Mortsel (BE)

(73) Assignee: AGFA Offset BV, Mortsel (BE)

(21) Appl. No.: 18/257,321

(22) PCT Filed: Nov. 15, 2021
(86) PCT No.: PCT/EP2021/081684

§ 371 Date: Jun. 14, 2023

(30) Foreign Application Priority Data
Dec. 16, 2020 (EP) 20214424.2

(51) Int. Cl. B41F 33/00; B41C 1/10

(52) U.S. Cl. CPC B41F 33/0045; B41C 1/1075; B41C 2210/04; B41P 2227/70; B41P 2233/11

(57) ABSTRACT

A method for setting up a lithographic printing press is provided which reduces the make-ready time of on-press developable printing plates so that less copies are wasted. The method uses an ‘ink boost’ at the startup of the press by presetting the inking system to a configuration whereby the amount of ink supplied to the plate is different from the amount prescribed by standard printing conditions. The ink boost can be positive or negative and can be made dependent on the difference in the image coverage between plates used in successive print jobs or on different paper types used in successive print jobs.

### TECHNICAL FIELD

The invention relates to an improved method for starting and adjusting a lithographic printing press until it produces sellable copies.

### BACKGROUND ART

Lithographic printing typically involves the use of a so-called printing master such as a printing plate which is mounted on a cylinder of a sheet-fed or web-fed printing press. The master carries a lithographic image on its surface and a print is obtained by applying ink to said image and then transferring the ink from the master onto a receiver material, which is typically paper. In conventional lithographic printing, ink as well as an aqueous liquid called dampening solution are supplied to the lithographic image which consists of oleophilic (or hydrophobic, i.e. ink-accepting, water-repelling) areas as well as hydrophilic (or oleophobic, i.e. water-accepting, ink-repelling) areas. In offset printing, the lithographic plate is mounted on a plate cylinder onto which ink and dampening solution is supplied by the inking system and dampening system of the press and the ink that is accepted by the lithographic image is transferred via an intermediate carrier called the blanket cylinder onto an ink receiving material such as paper.

Lithographic printing plates are generally obtained by the image-wise exposure and development of a so-called lithographic printing plate precursor which comprises a heat- or light-sensitive coating on a lithographic support. The exposure of the coating to heat or light, typically by means of a digitally modulated exposure device such as a laser, triggers a (physico-)chemical process in the coating, such as ablation; insolubilization by polymerization, by cross-linking of a polymer or by particle coagulation of a thermoplastic polymer latex; and solubilization by the destruction of intermolecular interactions or by increasing the penetrability of a development barrier layer. Although some plate precursors are capable of producing a lithographic image immediately after exposure, the most popular lithographic plate precursors require wet processing since the exposure produces a difference in solubility or a difference in the rate of dissolution in a developer between the exposed and the non-exposed areas of the coating. In positive working lithographic plate precursors, the exposed areas of the coating dissolve in the developer while the non-exposed areas remain resistant to the developer. In negative working lithographic plate precursors, the non-exposed areas of the coating dissolve in the developer while the exposed areas are resistant to the developer. Most lithographic plate precursors contain a hydrophobic coating on a hydrophilic support, so that the parts of the image which are resistant to the developer define the ink-accepting, hence printing areas (also called image areas) of the plate while the hydrophilic support is revealed by the dissolution of the coating in the developer at the non-printing (non-image) areas.

A popular type of lithographic printing plate precursors are so-called photopolymer plates which usually comprise a negative-working image recording layer and a protective overcoat. Upon image-wise exposure to light or heat, the image recording layer undergoes a chemical reaction whereby the layer hardens, i.e. becomes insoluble or non-dispersible in the developing solution through photopolymerization and/or photocrosslinking. The overcoat protects the image recording layer from scratching or contamination. Photopolymer plates which work by free-radical polymerization or crosslinking typically contain an overcoat which also acts as an oxygen barrier layer which increases the sensitivity of the plate by reducing the quenching by oxygen of the free radicals that are generated in the image recording layer by the image-wise exposure.

The conventional method of making photopolymer plates comprises first an image-wise exposure step of the plate precursor with a laser, followed by an optional “pre-heat” step to enhance the polymerization and/or crosslinking reaction of the radicals which have been generated in the image recording layer by the exposure, a wash step to remove the protective overcoat, an alkaline developing step to remove unexposed areas of the image recording layer, and a rinse and gum step. Over the past years, the market has partially evolved towards more simplified and more sustainable workflows wherein the pre-heat step and/or wash step are eliminated or wherein development and gumming are carried out in a single step.

More recently, on-press processing wherein the plate is mounted on the press and the image is developed by interaction with the ink and/or the dampening solution that are supplied to the plate during the start of the printing press, has attracted interest in the market. Plate precursors which are especially designed for on-press processing are sometimes designated as “process-free” or “DOP” (Development On Press) plates. During the press start, DOP plates develop a lithographic image because the non-printing areas of the coating are removed by the ink and/or by the dampening solution while the printing areas are resistant thereto. Since the surface of the plate changes while the image is developing, the relative amounts of ink and dampening solution that are accepted by the plate surface change continuously until the lithographic image is completely developed. This typically results in a lengthening of the so-called make-ready process of the press, as will be explained below.

“Make-ready” is a term which defines all the operations necessary to start and set up a printing press until it produces sellable copies. In a conventional make-ready procedure, the initial setting of the inking system is selected in accordance with the image on the plate (more printing areas require more ink) and with the known relation between the amount of the ink supply and the color density obtained on the printed copies. Said relation depends on the specific combination of a given receiver material, colorant, screening and ink, which may be called a standard printing condition. Standard printing conditions are usually collected by color measurements on the press which has been carefully set up to that specific printing condition. In spite of these known relations between ink supply and color density, it is still necessary to adjust the inking system once the press has started, because each print job has a different image. As a result, the make-ready process involves additional fine-tuning of the ink supply for that particular image, in order to obtain a stable setting which produces a color density on the printed copies that matches the target color density, meaning that the difference between the measured color and the target color is within an accepted tolerance, e.g. the ΔE deviation defined in ISO standard 12647-2 (2013).

Besides the optimization of the color density, also the registration of the plates in a multi-color print job requires fine-tuning. In a conventional make-ready process, the initial sheets which come off the press are checked by the press operator for registration, which is adjusted by changing the position of the plates on the plate cylinder in both dimensions as needed. After waiting until a proper ink/water balance and a steady ink flow on the ink rollers is achieved, the operator also measures the color density of test patches on the printed copies and adjusts the ink supply in order to obtain the target color. This sequence of color measurement and ink supply adjustment is repeated until production quality is obtained. In more recent years, the positioning of the plates and the ink supply adjustment has become automated. Make-ready is achieved in modern presses without human intervention, by integrated color control systems which automatically adjust the ink supply to each plate, based on color data measurements on the printed copies while the press is running at full speed. Said color data may be densitometric (color density) or colorimetric (L*, a*, b*) data. Examples of such systems are described in e.g. U.S. Pat. No. 6,024,018 and US2006/0170996.

In spite of the progress made, installing a new set of plates and adjusting the press to the new print job takes several minutes, depending on the degree of automation of the particular press and the skill of the operator. As a result, a few hundred printed copies may be lost during make-ready and there is still a need to shorten the make-ready process, especially in view of the competition with digital printing techniques, such as inkjet printers, which immediately print at production quality.

The problem of shortening the make-ready process has become more important when DOP plates are being used. As a lithographic plate rotates into contact with the blanket and then separates from it, the ink on the plate partially transfers to the blanket. Likewise, not all the ink transfers from the blanket cylinder onto the paper. Printing presses are designed to print the same image on a large number of copies, so it is not a problem that just a part of the ink transfers from the plate to the paper: more ink is added to the image areas on the plate during each revolution of the cylinders and after some number of initial startup rotations, the ink flow off the plate becomes equalized to the ink flow onto the plate, and similarly the ink flow off the blanket onto the paper becomes equalized to the ink flow onto the blanket. However, such equalization is not readily obtained with a DOP plate, because the undeveloped plate can accept ink over its complete surface, while the developed plate accepts ink only on the printing areas of the lithographic image. As a result, the amount of ink required by the plate and the lateral distribution of the ink that is required by the developing image changes continuously during the startup of the press until the image on the plate has developed completely.

This problem may become even worse in presses which are equipped with an integrated color control system, as will be illustrated by the following example. When the press is started, a DOP plate accepts ink over its complete surface as long as the image has not developed, i.e. as long as the non-image areas have not been removed. As a result, a lot of ink is consumed during the first revolutions of the cylinders, resulting in a drained inking system, and by the time the lithographic image has fully developed, the inking system is no longer capable of supplying a sufficient amount of ink and the printed copies have a color density far below target. The color density drop is detected by the color control system and the ink supply is then automatically adjusted so as to feed more ink to the plate. The compensation however is too strong, due to the large difference between the printed color density and the target value, and the image areas on the printed copies evolve from too low to too high a density. This will again be detected by the system which then reduces the ink supply to an amount that is actually too low, etc. The resulting oscillation of the setting of the inking system lengthens the time required to obtain a stable printing regime, i.e. a long make-ready time during which many copies are wasted.

U.S. Pat. No. 6,477,954 discloses a method for presetting the inking system before starting a lithographic press, wherein the image coverage distribution is taken from a plate scanner or from the digital image file that was used for the exposure of the plate, so that the lateral distribution of the ink is preset in accordance with the image to be printed. DE 10 2012 005784 A1 discloses a make-ready method wherein a control computer compares the contents of the print images of two consecutive print jobs and determines whether and in which color zones more or less color is required, and then adjusts the ink supply at the start of the second print job accordingly in order to reduce the make-ready time. However, these prior art methods do not take into account the problems described above in relation to DOP plates.

### SUMMARY OF INVENTION

It is therefore an object of the present invention to provide a method of setting up a lithographic printing press with a DOP plate, whereby the make-ready time and the number of wasted copies are reduced. This object is realized by method which is defined claim 1.

According to a first aspect of the present invention, the make-ready time can be reduced when a DOP plate is used which consumes more ink during the on-press development than a conventional (off-press processed) plate. In accordance with the present invention, the ink system is preset to supply an amount of ink which is too high compared to the ink supply that is prescribed in the standard printing conditions of that press. Such “ink boost” reduces the above described color density drop on the printed copies which otherwise would be detected by the integrated color measurement system, thereby avoiding the mentioned overshoot of the inking system adjustment and obtaining a shorter make-ready time. Of course, similar advantages will be obtained by the method of the present invention in embodiments wherein the color measurement and inking adjustment are done completely manually or in a semi-automated manner.

According to a second aspect of the invention, the make-ready time can be reduced when DOP plates of successive print jobs have a large difference in image coverage. The ink film thickness in the inking system at startup of the press still reflects the image of the plate used in the previous print job. The lithographic image of the previous plate may have a coverage (percentage of the image occupied by printing areas) which is very different from the image of the next print job. For example, when the image of the previous plate has a lower image coverage than the successive plate, the conventional make-ready process requires that the ink supply to the successive plate is gradually increased in order to achieve the target color density on the printed copies. In another example, the overall image coverage may be the same as in the previous job, but the lateral distribution of the image coverage may be different, and also then additional fine-tuning of the inking system is required which results in a long make-ready time. Such problems can also be solved by the method of the present invention: the make-ready time can be reduced by providing an ink boost up-front which takes into account the mentioned difference in ink coverage between DOP plates of successive print jobs. When the plate of the previous print job has a lower image coverage, the ink boost presets the inking system to a higher amount of ink than normally would be used based on the image of the new plate, resulting in a faster make-ready time. When the previous plate had a higher coverage, the inking system is preset to provide less ink than the normal amount in order to shorten the make-ready time. The latter embodiment of the invention will be referred to hereafter as a method which provides a ‘negative ink boost’, as explained in more detail below.

According to a third aspect of the invention, the make-ready time of DOP plates can be reduced when the ink receiving material is switched between two successive print jobs from one kind to another. For example, when a printer starts a press run with uncoated paper, he will set the ink supply to the amount prescribed by the standard printing conditions for that kind of paper; however when coated paper, which requires less ink than uncoated paper, was used in the previous print job, the amount of ink in the inking system at the start of the print job with uncoated paper will be lower than the amount set by the printer because the inking system still carries the ink film of the first print job. According to the present invention, the make-ready time can then be reduced by applying a positive ink boost at the start of the second print job. Vice-versa, a negative ink boost is applied when the press is switched from uncoated to coated paper.

In summary, the methods of the present invention provide a (positive or negative) ink boost by presetting the inking system to a configuration which reduces the make-ready time so that less printed copies are wasted. In preferred embodiments of the present invention, less than 150 printed copies have to be discarded until completion of the make-ready process. In more preferred embodiments, less than 100 or even less than 75 waste copies have to be printed until make-ready.

### BRIEF DESCRIPTION OF DRAWINGS

FIG. 1 shows a typical inking and dampening system of a lithographic printing station, as known from the prior art.

### DESCRIPTION OF PREFERRED EMBODIMENTS

### Definitions

The term “aryl” herein is preferably phenyl, benzyl, tolyl, ortho- meta- or para-xylyl, naphthyl, anthracenyl, phenanthrenyl, and/or combinations thereof. The heteroaryl group is preferably a monocyclic or polycyclic aromatic ring comprising carbon atoms and one or more heteroatoms in the ring structure, preferably 1 to 4 heteroatoms, independently selected from nitrogen, oxygen, selenium and sulfur. Preferred examples thereof include an optionally substituted furyl, pyridinyl, pyrimidyl, pyrazoyl, imidazoyl, oxazoyl, isoxazoyl, thienyl, tetrazoyl, thiazoyl, (1,2,3)triazoyl, (1,2,4)triazoyl, thiadiazoyl, thiophenyl group and/or combinations thereof. The optionally substituted heteroaryl is preferably a five- or six-membered ring substituted by one, two or three oxygen atoms, nitrogen atoms, sulfur atoms, selenium atoms or combinations thereof. Examples thereof include furan, thiophene, pyrrole, pyrazole, imidazole, 1,2,3-triazole, 1,2,4-triazole, tetrazole, oxazole, isoxazole, thiazole, isothiazole, thiadiazole, oxadiazole, pyridine, pyridazine, pyrimidine, pyrazine, 1,3,5-triazine, 1,2,4-triazine or 1,2,3-triazine, benzofuran, benzothiophene, indole, indazole, benzoxazole, quinoline, quinazoline, benzimidazole or benztriazole.

The term “alkyl” herein means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc. Preferably, the alkyl group is a C₁ to C₂₀-alkyl group; more preferably the alkyl group is a C₁ to C₆-alkyl group. Most preferably the alkyl is a methyl group. Cycloalkyls include for example, substituted or unsubstituted cyclopropyl, cyclopentyl, cyclohexyl, 4-methylcyclohexyl, and cyclooctyl groups.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

The optional substituents represent an alkyl, cycloalkyl, alkenyl or cycloalkenyl group, an alkynyl group, an aryl or heteroaryl group, an alkylaryl or arylalkyl group, an alkoxy group such as methoxy, ethoxy, iso-propoxy, t-butoxy, (2-hydroxytetradecyl)oxy, and various other linear and branched alkyleneoxyalkoxy groups; an aryloxy group, a thio alkyl, thio aryl or thio heteroaryl group, a hydroxyl group, —SH, a carboxylic acid group or an alkyl ester thereof, a sulfonic acid group or an alkyl est2.5er thereof, a phosphonic acid group or an alkyl ester thereof, a phosphoric acid group or an alkyl ester thereof, an amino group, a sulfonamide group, an amide group, a nitro group, a nitrile group, a halogen such as fluoro, chloro, or bromo, or a combination thereof.

A suitable alkenyl group herein is preferably a C₂ to C₆-alkenyl group such as an ethenyl, n-propenyl, n-butenyl, n-pentenyl, n-hexenyl, iso-propenyl, iso-butenyl, iso-pentenyl, neo-pentenyl, 1-methylbutenyl, iso-hexenyl, cyclopentenyl, cyclohexenyl and methylcyclohexenyl group.

A suitable alkynyl group herein is preferably a C₂ to C₆-alkynyl group; a suitable aralkyl group is preferably a phenyl group or naphthyl group including one, two, three or more C₁ to C₆-alkyl groups; a suitable aralkyl group is preferably a C₁ to C₆-alkyl group including an aryl group, preferably a phenyl group or naphthyl group.

A cyclic group or cyclic structure herein includes at least one ring structure and may be a monocyclic- or polycyclic group, meaning one or more rings fused together.

### Press Make-Ready Method

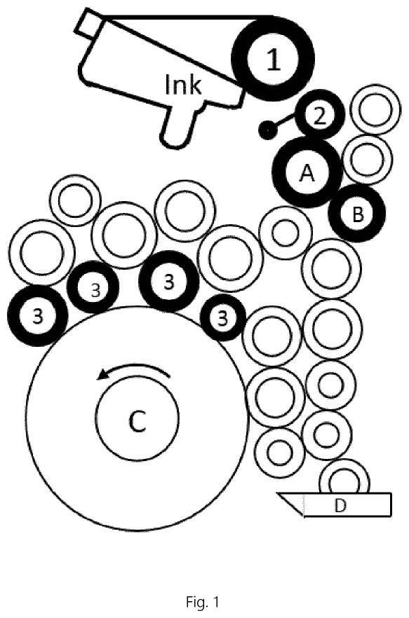

The amount of ink which is supplied to the plate material at the beginning of the make-ready process of the present invention can be controlled in a number of ways, as explained hereafter with reference to FIG. 1.

A typical inking system of a lithographic press comprises a train of a plurality of rollers which supply the ink from an ink reservoir (designated by “Ink” in FIG. 1), called “ink tray” or “ink fountain”, to the plate. The ink is picked up in the ink tray by the “ink tray roller” (1) and the thickness of the ink film on the ink tray roller is controlled by an “ink blade”. The width of the gap between the ink blade and the ink tray roller defines the thickness of the ink film that is allowed to pass from the ink tray to the rest of the inking system. The gap can be adjusted very precisely by screws called “ink keys” which allow to control the lateral distribution of ink through the system: a large number of ink keys are lined up in a series across the width of the ink tray and can be adjusted one by one, depending on the lithographic image on the plate. As a result, the ink supply is laterally (along the axis of the rollers) split in a plurality of inking zones and the ink supply to each zone is controlled by a specific ink key. A plate that needs additional ink in its center, for example, requires that the ink keys in the center are loosened. So in a preferred embodiment of the present invention, the ink boost to be applied at startup of the press can be configured by changing the ink keys (loosening for a positive ink boost; tightening for a negative ink boos), as will further be described below.

Other preferred methods for providing the ink boost involve the adjustment of the contact between the ductor roller (2) and the ink tray roller (1). The ductor roller (2) is the next roller in the inking system that accepts the ink from the ink tray roller (1). In a typical lithographic press, the ductor (2) does not contact the ink tray roller (1) permanently but oscillates back and forth so as to make an intermittent contact with the ink tray roller (1). The thickness of the ink film transferred to the ductor can be adjusted by changing the rotation speed of the ink tray roller or by changing the frequency and/or the time of each contact between the ink tray roller and the ductor roller. A higher contact frequency and/or a longer contact time produce a thicker film of ink on the ductor roller (2) and, as a result, a higher ink supply to the plate.

The next roller (A) which accepts the ink from the ductor roller (2) will be referred to herein as the “ink transfer roller”. The ink transfer roller (A) supplies the ink to the rest of the inking system and the ink is then distributed over the plate by the rollers (3) which make contact with the lithographic image on the plate. The dampening solution (D) is supplied to the plate by roller (4). The plate is mounted on plate cylinder (C).

The amount of ink that is supplied by the inking system to the plate is determined by the ink film thickness on the ink transfer roller (A) which can be measured with a mechanical wet film thickness gauge. The ink boost used in the method of the present invention produces an ink film thickness on roller (A) which differs from the standard value (without ink boost) by at least 10%. For the sake of clarity, the difference is quantified herein by the following formula, of which the result is referred to herein as the “RIFT” parameter (Relative Ink Film Thickness).

RIFT=absolute value of [(IB/IS)−1]*100

wherein IB is the actual ink film thickness on roller A with the ink boost at the start of the press run, and IS is the standard ink film thickness on roller A which corresponds to the standard printing conditions of the press for that particular print job. IB and IS can be measured as explained in the Examples section. Both values of course have to be measured in the same inking zone.

The ‘standard ink film thickness’ IS corresponds to the normal setting of the press and is equal to the film thickness on roller A that is reached as soon as the make-ready is finalised, i.e. when the inking system of the press has reached a steady state because the measured color data match the target color data, i.e. within the ΔE deviation defined in ISO standard 12647-2 (2013). From that moment onwards, the ink film thickness remains essentially the same until the end of the press run. As a result, it is convenient to measure IS at the end of the press run, while IB is to be measured at the start of the press run, as described in the Examples.

As explained above, IB may be higher than IS (positive ink boost) or lower than IS (negative ink boost). In both embodiments, the ink boost is quantified according to the above formula as the absolute value of the ratio IB/IS, expressed as a percentage versus IS. For example, an actual ink film thickness IB of 20 μm and a standard ink film thickness IS of 15 μm defines a positive ink boost having a RIFT value equal to 33% (20/15=1.33, i.e. a 33% increase), while a negative boost obtained by IB=15 μm and IS=20 μm results in a RIFT value of 25% (15/20=0.75 or a 25% decrease).

The maximum value of the RIFT parameter is in principle different for each particular inking system but may be as high as 300%, depending on the type of plate or on the difference in image coverage between two successive print jobs. Preferred RIFT values range from 30% to 250%, more preferably from 50% to 200%. Values above 100% can only relate to a positive ink boost; in view of the above definition, it is clear that the maximum RIFT value of a negative ink boost is less than 100%: for example the values IB=0.5 μm and IS=20 μm produce a RIFT value of 97.5%. Preferred RIFT values of a negative ink boost range from 10% to 90%, more preferably from 20% to 80% and most preferably from 30% to 70%.

A large difference in the total image coverage of the plates used in successive print jobs can be compensated with an overall ink boost, e.g. by adjusting the contact between the ink tray roller and the ductor roller of the inking system, as explained above. A similar overall ink boost can also be used to compensate a switch from one kind of ink receiving material to another, e.g. from coated paper to uncoated paper or vice-versa. Differences in the lateral distribution of the image coverage on the plates used in successive print jobs can be compensated with “specific ink boosts”, i.e. adjustments of the ink film thickness in individual inking zones by setting the corresponding ink keys to a different value than prescribed by the standard printing conditions. Both the overall image coverage and the image distribution can be obtained by visual inspection of the image, by scanning the image on the plate or, more preferably, directly from the computer-to-plate file that was used for the exposure of the plate material.

Specific ink boosts which are applied to individual ink keys require a separate value of IB and IS in each inking zone. In such embodiment, the method of the present invention may be applied on a single inking zone, but more preferably the method is applied on multiple inking zones simultaneously, wherein each inking zone is set to its specific RIFT value. Most preferably, the method of the present invention is applied on most or even on all the inking zones simultaneously. Such methods involving multiple ink keys are especially advantageous to obtain a faster make-ready when the plate carries an image that differs significantly from the plate used in the previous print job. A positive ink boost may be applied to an inking zone which has a local image coverage that is higher than in the previous plate, while a negative ink boost may be applied to another inking zone, which has a local image coverage that is lower than in the previous plate.

The above mentioned methods for providing the ink boost may be combined. For example, an overall ink boost may be applied by adjusting the rollers of the inking system and simultaneously one or more ink keys may be adjusted in order to provide a specific ink boost to the corresponding inking zone(s).

Although the RIFT parameter is obtained by measuring the values of IB and IS as defined above, it shall be clear that such measurement is not a step that is part of the method of the present invention. Instead, the measurements are made in order to establish whether the specific value of the RIFT parameter complies with the limit of at least 10%. In other words, methods wherein a RIFT value of at least 10% is used shall be considered as methods according to the invention, regardless whether the value is measured or not.

### Printing Plate Material and Image-Wise Exposure

The printing plate material used in the method of the present invention is obtained by off-press exposure and on-press development of a lithographic printing plate precursor.

The lithographic printing plate precursor preferably comprises an imagable coating on a hydrophilic support. The imagable coating comprises an image recording layer, optionally combined with one or more additional layers, e.g. a layer located between the hydrophilic support and the image recording layer, referred to hereafter as “undercoat”, or a layer provided on top of the image recording layer, referred to hereafter as “overcoat”.

The image recording layer may be positive- or negative-working and may be sensitive to ultraviolet (UV) light, in particular to near-UV light in the wavelength range from 300 to 400 nm; to violet light, i.e. wavelengths ranging between 400 and 450 nm; to blue, green or red light i.e. wavelengths ranging between 450 and 750 nm; and/or to infrared (IR) light, especially near-IR light i.e. wavelengths ranging from 750 to 1500 nm, more preferably 780 to 850 nm.

The plate precursor used in the method of the present invention may be image-wise exposed to UV, violet or IR light, preferably by means of a laser. The UV and violet light is preferably radiation having a wavelength in the range from 350 to 450 nm, more preferably from 360 to 420 nm and most preferably from 400 to 410 nm. Preferred UV and violet lasers are laser diodes, in particular a gallium-nitride diode, emitting at 375 nm or 405 nm respectively. Also a frequency-doubled gallium arsenide diode emitting at 410 nm can be used. The IR light is preferably near-IR radiation having a wavelength in the range from 750 to 1100 nm, more preferably from 780 to 850 nm. Preferred IR lasers are laser diodes emitting at about 830 nm or a Nd:YAG laser emitting at 1064 nm.

The sensitivity of the plate precursor, defined as the energy density of the laser beam measured at the surface of the coating of the plate, which is necessary to produce the lithographic image, is generally between 0.01 and 250 mJ/cm², more preferably between 0.1 and 10 mJ/cm² for plates sensitized to (ultra)violet light and 50 to 200 mJ/cm² for plates sensitized to infrared light.

A preferred embodiment of the image recording layer is negative-working and sensitive to near-IR light. Two types of such a layer and preferred methods of on-press development will be described in more detail below.

### Support

The support has a hydrophilic surface or is provided with a hydrophilic layer. Most preferred is a grained and anodized aluminum support, well known in the art. Suitable supports are for example disclosed in EP1843203 (paragraphs [0066] to [0075]). The surface roughness obtained after the graining step, expressed as arithmetical mean center-line roughness Ra (ISO 4287/1 or DIN 4762), may vary between 0.05 and 1.5 μm, more preferably from 0.3 to 0.6 μm. By anodizing the aluminum support, an Al₂O₃ layer is formed of which the weight (g/m² Al₂O₃) may vary between 1 and 8 g/m², more preferably between 2 and 3 g/m².

The grained and anodized aluminum support may be subjected to a so-called post-anodic treatment and/or a pore widening treatment. Suitable examples of post-anodic treatment are treatments with poly(vinylphosphonic acid) or derivatives thereof, with poly(acrylic acid), with potassium fluorozirconate or a phosphate, with an alkali metal silicate, or combinations thereof. Alternatively, the support may be treated with an adhesion promoting compound such as those described in EP1788434 in [0010] and in WO 2013/182328.

Besides an aluminum support, a plastic support, for example a polyester support, provided with one or more hydrophilic layers as disclosed in for example EP 1025992 may also be used.

### Image Recording Layer A

The image recording layer of type A is negative working and comprises hydrophobic thermoplastic polymer particles which fuse upon heating and thereby become resistant to ink and dampening solution. In practice, the heat is applied by a scanning infrared laser and the imagable coating contains a compound that absorbs IR light and converts the absorbed energy into heat. Said compound may be a pigment such as carbon black, but is more preferably an IR dye. The IR dye or pigment may be added to the image-recording layer itself but may also or exclusively be added to the optional undercoat or overcoat. Preferred IR dyes have a light absorption peak between 750 nm and 1300 nm, more preferably between 780 nm and 1100 nm, and most preferably between 800 nm and 850 nm. Suitable classes of IR dyes are merocyanines, indoanilines, oxonoles, pyrilium dyes, squarilium dyes and cyanine dyes. Heptamethine cyanine dyes are highly preferred. Specific examples of suitable IR dyes are described in e.g. EP823327, EP978376, EP1029667, EP1053868, EP1093934; EP1359008; WO1997/039894 and WO2000/029214.

Specific examples of suitable hydrophobic thermoplastic polymers are e.g. polyethylene, poly(vinyl chloride), poly(methyl (meth)acrylate), poly(ethyl (meth)acrylate), poly(vinylidene chloride), poly(meth)acrylonitrile, poly(vinyl carbazole), polystyrene or copolymers thereof. Polystyrene and poly(meth)acrylonitrile or their derivatives are highly preferred embodiments. According to such preferred embodiments, the thermoplastic polymer comprises at least 50 wt % of polystyrene, and more preferably at least 60 wt. % of polystyrene. In order to obtain sufficient resistivity towards organic chemicals, such as the hydrocarbons used in plate cleaners, the thermoplastic polymer preferably comprises at least 5 wt. %, more preferably at least 30 wt. % of nitrogen containing monomeric units or of units which correspond to monomers that are characterized by a solubility parameter larger than 20, such as (meth)acrylonitrile. According to the most preferred embodiment, the thermoplastic polymer is a copolymer consisting of styrene and acrylonitrile units in a weight ratio between 1:1 and 5:1 (styrene:acrylonitrile), e.g. in a 2:1 ratio.

The weight average molecular weight of the thermoplastic polymer particles may range from 5,000 to 1,000,000 g/mol. The hydrophobic particles preferably have a number average particle diameter below 200 nm, more preferably between 10 and 100 nm. The amount of hydrophobic thermoplastic polymer particles contained in the image-recording layer is preferably between 20 wt % and 65 wt. % and more preferably between 25 wt. % and 55 wt % and most preferably between 30 wt. % and 45 wt. %.

The thermoplastic polymer particles are preferably dispersed in a hydrophilic binder, which may be selected from e.g. homopolymers and copolymers of vinyl alcohol, acrylamide, methylol acrylamide, methylol methacrylamide, acrylic acid, methacrylic acid, hydroxyethyl acrylate, hydroxyethyl methacrylate or maleic anhydride/vinylmethylether copolymers. The hydrophilicity of the (co)polymer or (co)polymer mixture used is preferably the same as or higher than the hydrophilicity of polyvinyl acetate hydrolyzed to at least an extent of 60 wt. %, preferably 80 wt. %.

After image-wise exposure, the image recording layer of this embodiment is developed on the press with dampening solution and/or ink, i.e. the non-printing areas of the image can be removed by the dampening solution and/or ink that is supplied to the plate during the start of the lithographic printing press. Such embodiments preferably contain a leuco dye or a thermochromic IR dye that produces a visible image immediately upon exposure (i.e. before development), so that the image can be checked before the plate is mounted on a plate cylinder of the press. Such leuco dye or thermochromic IR dye may be added to any layer of the imagable coating. Preferred thermochromic IR dyes are described in EP1736312.

After being mounted on the press, the plate is processed by rotating the plate cylinder while feeding dampening solution and/or ink to the exposed precursor. In a preferred embodiment, only dampening solution is supplied to the plate in the first 60 seconds, more preferably the first 30 seconds and most preferably the first 15 seconds, after the start of the press and then the ink supply is also switched on. In an alternative embodiment, supply of dampening solution and ink can be started simultaneously or only ink can be supplied during a number of revolutions before switching on the supply of dampening solution. Preferred embodiments of the imagable coating require less than 25 printed copies to remove the non-printing areas of the image completely from the substrate.

### Image Recording Layer B

The image recording layer of type B is negative working and comprises a photopolymerizable and/or photocrosslinkable composition which is sensitized to (ultra)violet, visible or IR light. The peak sensitivity of the composition may be above 420 nm, but a better daylight stability can be obtained with compositions that have their peak sensitivity at shorter wavelength, preferably below 420 nm and more preferably below 410 nm. The availability of laser diodes emitting in the near UV wavelength range, e.g. at 365 or 375 nm, makes compositions having a peak sensitivity outside the visible wavelength range, i.e. below 400 nm, particularly advantageous. According to another embodiment, the peak sensitivity of the composition is in the IR wavelength range, preferably near-IR light having a wavelength from 750 to 1100 nm, and more preferably from 780 to 850 nm.

The image recording layer B preferably has a coating thickness between 0.2 and 5.0 g/m², more preferably between 0.4 and 3.0 g/m² and most preferably between 0.6 and 1.5 g/m².

A preferred photopolymerizable or photocrosslinkable composition includes a polymerizable or crosslinkable compound, an initiator, an (ultra)violet sensitizer and/or infrared sensitizer, and a polymeric binder.

The polymerizable or crosslinkable compound is preferably a monomer or oligomer including at least one terminal ethylenic group, hereinafter also referred to as “free-radical polymerizable monomer”, and the initiator is a compound capable of generating free radicals upon exposure, optionally in the presence of a sensitizer (hereinafter said initiator is referred to as “free-radical initiator”).

Suitable free-radical polymerizable monomers include, for example, multifunctional (meth)acrylate monomers such as (meth)acrylate esters of ethylene glycol, trimethylolpropane, pentaerythritol, ethoxylated ethylene glycol and ethoxylated trimethylolpropane, multifunctional urethanated (meth)acrylate, and epoxylated (meth)acrylate), and oligomeric amine diacrylates. The (meth)acrylic monomers may also have another double bond or epoxide group in addition to the (meth)acrylate group. The (meth)acrylate monomers may also contain an acidic (such as carboxylic acid) or basic (such as amine) group. Suitable free-radical polymerizable monomers are disclosed in [0042] and [0050] of EP2916171 and are incorporated herein by reference.

Suitable free-radical initiators are described in e.g. WO2005/111727 from page 15 line 17 to page 16 line 11, in EP1091247A and in EP3594009A. Preferred free-radical initiators are for example hexaaryl-bisimidazole compound (HABI; dimer of triaryl-imidazole), aromatic ketones, organic peroxides, thio compounds, keto-oxime ester compounds, borate compounds, azanium compounds, metallocene compounds, active ester compounds and compounds having a carbon-halogen bond.

A preferred free-radical initiator is an optionally substituted trihaloalkyl sulfone compound (referred to hereafter as “THS” compound) wherein halo independently represents bromo, chloro or iodo and sulfone is a chemical compound containing a sulfonyl group (—SO₂—) attached to two carbon atoms. More preferably, the THS compound is an optionally substituted trihaloalkyl-(hetero)aryl sulfone, i.e. a compound wherein the sulfonyl group is attached to an optionally substituted trihaloalkyl group and to an optionally substituted aryl or optionally substituted heteroaryl group. The aryl group is preferably an optionally substituted phenyl, benzyl, tolyl or an ortho- meta- or para-xylyl, naphthyl, anthracenyl, phenanthrenyl, and/or combinations thereof. The heteroaryl group is preferably an optionally substituted monocyclic or polycyclic aromatic ring comprising carbon atoms and one or more heteroatoms in the ring structure, preferably 1 to 4 heteroatoms independently selected from nitrogen, oxygen, selenium and sulfur. Preferred examples thereof include furan, thiophene, pyrrole, pyrazole, imidazole, 1,2,3- or 1,2,4-triazole, tetrazole, oxazole, isoxazole, thiazole, isothiazole, thiadiazole, oxadiazole, pyridine, pyridazine, pyrimidine, pyrazine, 1,3,5-, 1,2,4- or 1,2,3-triazine, benzofuran, benzothiophene, indole, indazole, benzoxazole, quinoline, quinazoline, benzimidazole or benztriazole. The most preferred THS compound is an optionally substituted tribromomethyl-aryl sulfone, most preferably an optionally substituted tribromomethyl-phenyl sulfone.

The amount of the THS-initiator typically ranges from 0.1 to 30 wt. %, preferably from 0.5 to 10 wt. %, most preferably from 2 to 7 wt. % relative to the total dry weight of the non-volatile components of the photopolymerizable or photocrosslinkable composition.

Another group of preferred free-radical initiators are onium salts, in particular iodonium salts and sulfonium salts or mixtures thereof. Suitable classes of iodonium salts are optionally substituted diaryl iodonium salts or diheteroaryl iodonium salts. Specific examples of the diaryliodonium salts include diphenyliodonium, 4-methoxyphenyl-4-(2-methylpropyl) phenyliodonium, 4-chlorophenyl-4-phenyliodonium, 4-(2-methylpropyl) phenyl-tolyl iodonium, 4-hexyloxyphenyl-2,4,6-trimethoxyphenyliodonium, 4-hexyloxyphenyl-2,4-diethoxyphenyliodonium, 4-octyloxyphenyl-6-trimethoxyphenyliodonium, bis (4-tert-butylphenyl) iodonium and bis (4-isopropylphenyl) iodonium, 4-octyloxyphenyl phenyliodonium, [4-[(2-hydroxytetradecyl)-oxy]phenyl]phenyliodonium, 4-methylphenyl-4′-hexylphenyliodonium tetraphenylborate, 4-methylphenyl-4′-cyclohexylphenyliodonium, 4-hexylphenyl-phenyliodonium, 4-methylphenyl-4′cyclohexylphenyliodonium, 4-cyclohexylphenyl-phenyliodonium, 2-methyl-4-t-butylphenyl-4′-methylphenyliodonium, (4-tert-butyl-phenyl)-(4-methoxy-phenyl) iodonium, phenyl-(4-tert-butyl-phenyl) iodonium, phenyl-(4-cumyl-phenyl) iodonium, phenyl-(3-cumyl-phenyl) iodonium and/or mixtures thereof.

Preferred examples of the triarylsulfonium salts include triphenylsulfonium, dialkylphenacylsulfonium, dialkyl-4-hydroxyphenylsulfonium, bis (4-chlorophenyl) phenylsulfonium, triphenylsulfonium benzoyl formate, bis (4-chlorophenyl) phenylsulfonium benzoyl formate, bis (4-chlorophenyl)-4-methylphenylsulfonium bis (4-chlorophenyl)-4-methylphenylsulfonium, tris (4-chlorophenyl) sulfonium, tris 2,4-dichlorophenyl) sulfonium, bis (2,4-dichlorophenyl) phenyl sulfonium and bis (2,4-dichlorophenyl) 4-methoxyphenyl sulfonium.

Suitable counter ions of the onium salts are for example PF₆⁻, SbF₆⁻, AsF₆⁻ and organoboron anions, more preferably optionally substituted tetraphenylborate anions. The onium salts are preferably present in the image recording layer in an amount between 1 and 25 wt. %, more preferably in an amount between 5 and 20 wt. %, and most preferably in an amount between 10% and 16 wt. %.

The image recording layer B may also comprise a co-initiator which is used in combination with a free-radical initiator. Suitable co-initiators are disclosed in U.S. Pat. Nos. 6,410,205; 5,049,479; EP1079276, EP107792, EP1369232, EP1369231, EP1341040, US2003/0124460, EP1241002, EP1288720 and in the reference book including the cited references: Chemistry & Technology UV & EB formulation for coatings, inks & paints—Volume 3—Photoinitiators for Free Radical and Cationic Polymerization by K. K. Dietliker—Edited by P. K. T. Oldring (1991; ISBN 0947798161). Preferred co-initiators are disclosed in EP2916171A (par. [0051]) and are incorporated herein by reference. A highly preferred co-initiator is a tetraphenylborate, which may be added as a salt, e.g. sodium or potassium tetraphenylborate, or as the counter ion of another ingredient such as the onium initiators described above.

Suitable (ultra)violet sensitizers are dyes having a light absorption peak in the wavelength range from 320 nm to 500 nm, preferably from 350 to 450 nm and more preferably from 360 to 420 nm. Suitable (near-)infrared sensitizers are dyes having a light absorption peak in the wavelength range from 750 to 1100 nm, preferably from 780 to 850 nm and more preferably from 810 to 830 nm. The best daylight stability is achieved with sensitizers that have an absorption peak below 400 nm and/or above 750 nm. The mentioned absorption peak wavelengths are values as measured in the dry matrix of the imagable coating of the plate precursor.

Suitable (ultra)violet sensitizers are disclosed in e.g. EP1349006A. Preferred classes of (ultra)violet sensitizers are fluorenes, thioxanthones, (keto-)coumarines, pyrilium or thiopyrylium dyes. More preferred dyes have the general structure Sty-Ar-Sty wherein each “Sty” group is an optionally substituted styryl (C₆H₅—CH═CH—) group and Ar is an optionally substituted aromatic or an optionally substituted heteroaromatic group which forms a conjugated system with the Sty groups. The two Sty groups may be the same of different Examples of Ar are preferably derived from benzene, naphthalene, anthracene, fluorene, biphenyl, carbazole, furan, dibenzofuran, thiophene, dibenzothiophene, dithienothiophene, oxadiazole, thiadiazole, pyridine, pyrimidine and combinations of two or more of these groups which may be the same or different. Dyes wherein Ar is biphenyl or phenyl are the most preferred. Suitable examples of such distyryl-biphenyl compounds and distyryl-benzene compounds are disclosed in WO2005/029187 and WO2008/145528.

Suitable near-IR sensitizers include IR light absorbing dyes and pigments. A preferred pigment is carbon black. A preferred IR-dye has a light absorption peak between 750 nm and 1300 nm, more preferably between 780 nm and 1100 nm, and most preferably between 800 nm and 850 nm. Suitable IR-dyes are merocyanines, indoanilines, oxonoles, pyrilium dyes, squarilium dyes and cyanine dyes, in particular heptamethine cyanine dyes. Examples of suitable IR-dyes are described in e.g. EP823327, EP978376, EP1029667, EP1053868, EP1093934; EP1359008; WO97/39894 and WO00/29214. Highly preferred IR-dyes produce a visible image immediately upon the image-wise exposure, e.g. those disclosed in EP1736312, EP1910082 and WO2019/219560. Such thermochromic IR-dyes can also be used in the overcoat.

Also mixtures of sensitizers can be used, e.g. mixtures of two or more of the above mentioned dyes, or mixtures of the above dyes with other sensitizers. The overall concentration of the sensitizer(s) with respect to the total dry weight of the image recording layer is preferably from 0.25 to 25.0 wt. %, more preferably from 0.5 to 20.0 wt. % and most preferably from 1.0 to 10.0 wt %.

The binder can be selected from a wide series of organic polymers. Mixtures of different binders can also be used. Useful binders are described in WO2005/111727 page 17 line 21 to page 19 line 30, EP1043627 in paragraph [0013] and in WO2005/029187 page 16 line 26 to page 18 line 11. Specific examples of binders are described in U.S. Pat. No. 6,899,994; US 2004/0260050, US 2005/0003285, US 2005/0170286, US 2005/0123853 and EP2916171 in [0029], [0030] and [0031]. Other suitable binders as described in EP2471655, EP2492748 and EP2660068 include multifunctional thiols having 6 to 10 functional groups as a nucleus (central skeleton) and polymer chains connected to the nucleus through sulfide bonds. In addition, the image recording layer may optionally comprise one or more co-binders. Typical co-binders are water-soluble or water-dispersible polymers, such as, cellulose derivatives, polyvinylalcohol, polyacrylic acid poly(meth)acrylic acid, polyvinylpyrrolidone, polylactide, polyvinylphosphonic acid, synthetic co-polymers, such as co-polymers of an alkoxy polyethylene glycol (meth)acrylate. Specific examples of co-binders are described in US 2004/0260050, US 2005/0003285 and US 2005/0123853.

The image recording layer B may further include discrete particles, i.e. particulate shaped polymers including homopolymers or copolymers prepared from monomers such as ethylene, styrene, vinyl chloride, methyl acrylate, ethyl acrylate, methyl methacrylate, ethyl methacrylate, acrylonitrile, vinyl carbazole, acrylate or methacrylate, or mixtures thereof. Preferably the discrete particles are particles which are suspended in the polymerisable composition. The presence of discrete particles tends to promote developability of the non-image areas.

The image recording layer B may also include thermally reactive polymer fine particles including a thermally reactive group such as an ethylenically unsaturated group, a cationic polymerizable group, an isocyanate group, an epoxy group, a vinyloxy group, and a functional group having an active hydrogen atom, a carboxy group, a hydroxy group, an amino group or an acid anhydride. The average particle diameter of the polymer fine particle is preferably 0.01 μm to 3.0 μm. Particulate polymers in the form of microcapsules, microgels or reactive microgels are suitable as disclosed in EP1132200; EP1724112 and US2004/106060.

The image recording layer B may also comprise additional ingredients, such as leuco dyes which form a visible image upon the image-wise exposure, particles which protect the layer from mechanical damage, and an adhesion promoting compound, i.e. a compound which is capable of increasing the adhesion of the image areas to the hydrophilic support. Such an adhesion promotor may be present in the image recording layer and/or an optional undercoat.

Various surfactants may also be added to the image recording layer to allow or enhance the developability thereof. The mentioned particles that protect the layer from mechanical damage, such as scratches due to manual handling or plate handling equipment, may be inorganic particles, organic particles or fillers such as described in for example U.S. Pat. No. 7,108,956. More details of suitable spacer particles described in EP2916171A [0053] to [0056] are incorporated herein by reference.

After image-wise exposure, the image recording layer is developed on the press in a similar way as described above for image recording layer A. The optional overcoat described below is preferably removed together with the non-image areas of the recording layer in a single treatment. Alternatively, a pre-wash step may be carried out to remove the overcoat before subjecting the image recording layer to on-press development. The pre-wash step can be carried out in an off-press apparatus or by manually rinsing the plate precursor, either on- or off-press. The washing liquid is preferably water, more preferably tap water.

### Overcoat

Especially in the embodiment of image recording layer B, the coating preferably comprises an overcoat which acts as an oxygen barrier layer that increases the sensitivity of the plate by reducing the quenching by oxygen of the free radicals which are generated in the image recording layer by the image-wise exposure.

The overcoat is preferably easily removable during development and preferably adheres well to the photopolymerisable layer or an optional other layers of the coating. The overcoat is preferably soluble or dispersible in water or ink so that it can be removed easily by the dampening solution during on-press development. As a result, the overcoat preferably comprises a hydrophilic binder. Preferred binders which can be used in the top layer are disclosed in WO2005/029190 (page 36 line 3 to page 39 line 25), US 2007/0020563 (paragraph [0158]) and EP1288720A (paragraphs [0148] and [0149]), including the references cited in these patent applications. The most preferred binder of the overcoat is poly(vinyl alcohol) and/or derivatives of poly(vinyl alcohol). The poly(vinyl alcohol) has preferably a hydrolysis degree ranging between 74 mole % and 99 mole %, more preferably between 88 mole % and 98 mole %. The viscosity number of the poly(vinyl alcohol), which is related to the molecular weight and is measured as a 4 wt. % aqueous solution at 20° C. in accordance with DIN 53015, preferably ranges between 1 and 26, more preferably between 2 and 15, and most preferably between 2 and 10.

A mixture of hydrophilic binders may also be used, for example a mixture of two or more water-soluble polymers such as a combination of poly(vinyl alcohol) and poly(vinyl pyrrolidone), or a mixture of poly(vinyl alcohol)s and/or derivatives of poly(vinyl alcohol)s having a different hydrolysis and viscosity number. Modified poly(vinyl alcohol), e.g. poly(vinyl alcohol) having a carboxyl group and/or a sulfonic acid group may also be used, preferably together with unmodified poly(vinyl alcohol).

The overcoat may include a halogenated polymer which is preferably a hydrophobic polymer, i.e. not soluble or swellable in water at about neutral pH. This binder may be used in the form of a dispersion, i.e. an emulsion or suspension. The amount of the halogenated polymer may be between 30 wt. % and 96 wt. % versus the total dry weight of the overcoat, more preferably between 40 wt. % and 90 wt. % and most preferably between 50 wt. % and 85 wt. %. The halogenated binder preferably includes between 60 wt. % and 95 wt. % of monomeric units derived from vinylidene monomers such as vinylidene fluoride, vinylidene chloride, vinylidene bromide and/or vinylidene iodide.

The overcoat may comprise other ingredients such as anionic surfactants, e.g. sodium alkyl sulfate or sodium alkyl sulfonate, sodium dioctylsulfosuccinate, sodium dodecylbenzenesulfonate, and ammoniumlaurylsulfate; amphoteric surfactants, e.g. alkylaminocarboxylate and alkylamino-dicarboxylate; non-ionic surfactants, e.g. polyethylene glycol, polypropylene glycol, and copolymer of ethylene glycol and propylene glycol, polysiloxane surfactants, perfluorocarbon surfactants, alkylphenyl ethylene oxide condensate, alkoxylated alkylene diamines disclosed in EP1085380A (paragraph [0021] and [0022]); and various additives such as glycerine, pigments, matting agents or wetting agents as disclosed in EP2916171A, and/or (in)organic acids, e.g. the acids disclosed in EP2149071A page 27 lines 1 to 21. Also microparticles may be added to the overcoat, for example to reduce the tackiness or moisture sensitivity of the plate.

In a highly preferred embodiment of the plate precursor used in the present invention, the overcoat further comprises a thermochromic dye which produces a visible image upon image-wise exposure with IR light, as disclosed in WO2019/219560.

The coating thickness of the overcoat is preferably between 0.10 and 1.75 g/m², more preferably between 0.20 and 1.3 g/ml, and most preferably between 0.25 and 1.0 g/m². The sensitivity of plates comprising an image recording layer of the above described type B is not only dependent on the wavelength but also on the nature and the thickness of the overcoat: a plate with a thin overcoat is less protected against oxygen quenching and therefore requires more energy than a plate with a thick overcoat.

### EXAMPLES

### Examples 1-4

The plate precursor used in the Examples 1-4 was the commercially available Eclipse plate of AGFA NV, Belgium. Eclipse (registered trademark) is a DOP material comprising an image recording layer of the above described type B, which comprises an infrared-sensitized photopolymerizable composition. For each press run, 4 plates of size 1055 mm×811 mm were prepared to address the CMYK printing stations of the press described below. All the plates were exposed with the same test image at 2400 dpi by an Avalon N8-90 thermal plate setter using a 200 lpi Agfa Balanced Screening (all commercially available from AGFA NV) at an energy density of 130 mJ/cm². Plate linearization and calibration curves were setup before platemaking. The plate image coverage was 11% (C), 15% (M), 10% (Y) and 7% (K).

Without any off-press processing, the exposed printing plates were mounted on a Heidelberg Speedmaster XL 106 press which was equipped with an automatic AutoPlate plate changing system and an integrated Prinect Inpress Control system (all trademarks of Heidelberg Druckmaschinen, Germany). The latter system automatically carries out the make-ready process by on-the-fly measurement of the registration and the color data of the printed image, of which the results are used for the repositioning of the plates and adjustment of the ink keys settings as needed. Each print job was run with K+E Novaboard 4C 1090 Race Bio CMYK inks (trademark of Flint Group) and 3 vol. % of Saphira Fount 221 AF (trademark of Heidelberg Druckmaschinen, Germany) and 6.4 vol. % of isopropanol in water as dampening solution. Coated paper of 115 g/m² was used as receiver material. The printing speed used in all Examples was 13000 sheets per hour.

Table 1 shows the press startup parameters that were used in these Examples. The startup procedure comprised first a pre-dampening phase wherein only the dampening system was engaged (i.e. running into contact with the plate cylinder) during a number of revolutions (designated “X” in Table 1), followed by a pre-inking phase with also the inking rollers engaged during a number (“Y”) of revolutions. Printing was then started by feeding paper through the press (in Examples COMP-04 and INV-04, wherein Y=0, the ink rollers were also engaged upon starting the printing process).

In the Examples COMP-01 to COMP-04, the ink supply at said start of the inking system was set in accordance with the standard printing conditions (the settings of the dampening and the ink keys were as follows: water C-M-Y-K=33-33-34-32 resp.; ink C-M-Y-K=35-37-35-33). The same key settings were used in the Examples INV-01 to INV-04 but a positive ink boost was applied by prolonging the contact between the ductor roller and the ink tray roller, and then the ink film thickness was measured as described below.

TABLE 1

| | | Press | | #copies for | | |
|---|---|---|---|---|---|---|
| | INK | settings | | development | | #copies for |
| EXAMPLE | BOOST | X | Y | Image | Non-image | make-ready |
| COMP-01 | no | 6 | 9 | 25 | 25 | 180 |
| COMP-02 | | 9 | 12 | 20 | 25 | 160 |
| COMP-03 | | 3 | 6 | 20 | 15 | 175 |
| COMP-04 | | 6 | 0 | 25 | 25 | 180 |
| INV-01 | yes | 6 | 9 | 25 | 25 | 70 |
| INV-02 | (69%) | 9 | 12 | 25 | 25 | 70 |
| INV-03 | | 3 | 6 | 25 | 20 | 75 |
| INV-04 | | 6 | 0 | 25 | 20 | 75 |

The ink film thickness was measured as follows. Prior to the above described pre-dampening phase, the inking system was started without making contact with the plate and the ink film thickness was measured on ink transfer rollers A and B (see FIG. 1) using a mechanical wet film thickness gauge (model 234 R/I from Erichsen GmbH & Co. KG, Germany), which has a measuring accuracy of 1 μm. The result (IB) of the ink film thickness measurements for the Examples INV-01 to INV-04 was 22 μm (roller A) and 12 μm (roller B). The standard ink film thickness (IS) was measured in the same way, but at the end of the press run which was then in a steady state wherein the measured color data matched the target color data. The values of the thickness measurement, in the same inking zone as for IB, were 13 μm (roller A) and 9 μm (roller B). So the RIFT parameter of the ink boost used in the Examples according to the invention, defined above as the relative difference between the ink film thickness on roller A with and without the ink boost, was 69% (22/13=1.69). All the mentioned thickness values were measured on the same inking zone of the K (black color) station (the values obtained on the other color stations were quite similar).

The progress of the on-press development was evaluated by visual inspection of the printed copies: the number of copies required for complete disappearance of toning (ink acceptance at the non-image areas) and for reaching a good color density (as perceived by visual inspection) at the image areas was noted. Completion of the make-ready process was then established as the number of copies required to obtain a color density within a ΔE tolerance of ±3 versus target as determined by the Prinect Inpress Control system according to ISO standard 12647-2 (2013).

As demonstrated by the results in Table 1, both the comparative Examples and the Examples according to the invention produced satisfactory results for the on-press development: a low number of wasted sheets, equal to or less than 25 copies, was required to reach cleanout (complete removal of the plate coating in the non-image areas) and acceptable ink acceptance at the image areas. Nevertheless the color correction by the Prinect Inpress Control system required more time to reach production quality: between 160 and 180 wasted copies were required in the Examples COMP-01 to COMP-04, while the Examples INV-01 to INV-04 required less than half that number. Adjustment of the other press settings (X,Y) had only a minor impact on the make-ready time.

### Examples 5-6

These Examples demonstrate the advantage offered by the method of the present invention when switching from a press run with coated paper (115 g/m²) to a press run with uncoated paper (120 g/m²). The same materials and press startup procedure were used as in Examples 1-4 but now with X=5 and Y=8 and different kinds of paper. First, two comparative examples COMP-05 and -06 were run, with coated and uncoated paper respectively, and the ink film thickness was measured as explained above at the end of the press run (when the press had reached its standard conditions) so as to obtain the value of IS for printing on coated and uncoated paper respectively. Then, an intermediate press run was used to bring the inking system of the press back to the standard conditions for coated paper. Next, another press run was started with uncoated paper (Example INV-05), wherein the inking system was not set according to the standard conditions of the press; instead, the ink uptake of the ductor roller was increased by prolonging the contact with the ink tray roller, resulting in an ink boost as indicated in Table 2. Finally, another sequence followed which also comprised an intermediate run with coated paper and a press run on uncoated paper (Example INV-06) but now with a higher ink boost than in Example INV-05.

TABLE 2

| | | | | #copies for | | #copies |
|---|---|---|---|---|---|---|
| | | Ink film | | development | | for |
| | | thickness | INK | | Non- | make- |
| EXAMPLE | Paper | (μm) | BOOST | Image | image | ready |
| COMP-05 | coated | 14 (1) | — | 15 | 15 | 155 |
| COMP-06 | uncoated | 19 (1) | | 20 | 20 | 210 |
| <interm.> | coated | | | | | |
| INV-05 | uncoated | 26 (2) | 37% | 15 | 15 | 140 |
| <interm.> | coated | | | | | |
| INV-06 | uncoated | 36 (2) | 89% | 15 | 10 | 60 |

(1) measured at the end of the press run (IS)
(2) measured at the start of the press run (IB)

The results in Table 2, measured in the same way as explained for Examples 1-4, demonstrate first of all that the standard ink film thickness for printing on coated paper (14 μm) is lower than on uncoated paper (19 μm), as expected. As a result, Example COMP-06 required a long make-ready time because the ink film thickness at the start of the press run still corresponded to the printing condition of the previous run in COMP-05, which was too low for printing on uncoated paper. The ink film thickness measured on roller A at the start of the press run in Examples INV-05 and -06 was 26 μm and 36 μm respectively, indicating that an ink boost was applied with a RIFT value of 37% (26/19=1.37) and 89% (36/19=1.89) respectively, in order to compensate for the preceding run on coated paper. These ink boosts reduced the make-ready time from 210 copies (COMP-06) to 140 copies in Example INV-05 and 60 copies in Example INV-06.

### Examples 7-8

These Examples demonstrate the advantage offered by the method of the present invention when switching from a press run with plates having a low image coverage to a press run with plates having a high image coverage. The same materials and press startup procedure were used as in Examples 5-6, but the inks keys were set in accordance with the image coverage of the plates:
Examples COMP-07 and INV-07 with low image coverage: the plates were imaged to have a coverage of 3.9% (C), 4.3% (M), 3.8% (Y) and 4.2% (K); the initial key settings were as follows: Water C-M-Y-K=34-32-34-34; Ink C-M-Y-K=32-32-32-32.
Examples COMP-08 and INV-08 with high image coverage: the plates were imaged to have a coverage of 35.0% (C), 34.1% (M), 29.8% (Y) and 34.9% (K); the initial key settings were as follows: Water C-M-Y-K=34-32-34-34; Ink C-M-Y-K=44-43-42-45.

First, the two comparative examples COMP-07 and -08 were run, with the plates having a low and a high image coverage respectively, and the ink film thickness was measured as explained above at the end of the press run (when the press had reached its standard conditions) so as to obtain the value of IS for printing a low and a high image coverage respectively. Then, an intermediate press run was done with the low coverage plates to bring the inking system of the press back to the standard conditions for printing the low image coverage. Next, another press run was started with the plates having a low image coverage (Example INV-07), wherein the inking system was not set according to the standard conditions of the press; instead, the ink uptake of the ductor roller was increased by prolonging the contact with the ink tray roller, resulting in an ink boost as indicated in Table 3. This ink boost was given to compensate for the impact of the on-press development if the plates, as explained in Examples 1-4. A final press run was then started with the high coverage plates (Example INV-08), wherein a higher ink boost was applied than in Example INV-07 in order to compensate also for the switch from a low to a high image coverage.

TABLE 3

| | | | | #copies for | | #copies |
|---|---|---|---|---|---|---|
| | | Ink film | | development | | for |
| | Image | thickness | INK | | Non- | make- |
| EXAMPLE | coverage | (μm) | BOOST | Image | image | ready |
| COMP-07 | low | 11 (1) | — | 10 | 10 | 115 |
| COMP-08 | high | 15 (1) | | 15 | 10 | 200 |
| <interm.> | low | | | | | |
| INV-07 | low | 21 (2) | 91% | 10 | 10 | 60 |
| INV-08 | high | 29 (2) | 93% | 15 | 15 | 75 |

(1) measured at the end of the press run (IS)
(2) measured at the start of the press run (IB)

The results in Table 3, measured in the same way as explained for Examples 1-4, demonstrate first of all that the standard ink film thickness for printing a low coverage image (11 μm) is lower than a high coverage image (15 μm), as expected. As a result, Example COMP-08 required a long make-ready time because the ink film thickness at the start of the press run still corresponded to the printing condition of the previous run in COMP-07, which was too low for printing the high coverage image. The ink film thickness measured on roller A at the start of the press run in Examples INV-07 and -08 was 21 μm and 29 μm respectively, indicating that an ink boost was applied with a RIFT value of 91% (21/11=1.91) and 93% (29/15=1.93) respectively, in order to compensate for the preceding run with low coverage plates. The ink boost applied in Example INV-07 reduced the make-ready time from 115 (COMP-07) to 60 copies, demonstrating that the impact of the on-press development on the make-ready time can be reduced significantly. The switch from low to high image coverage in the comparative examples COMP-07 and -08 without ink boost resulted in a significant increase of the make-ready time from 115 to 200 copies. The ink boost applied in the examples according to the invention INV-07 and -08 however reduced the impact of said switch to a large extent (small increase from 60 to 75 copies).

1-10. (canceled)

11. A method for setting up a lithographic printing press which includes at least one print station having an inking system, a dampening system, a plate cylinder, and a blanket cylinder, wherein the inking system includes an ink tray equipped with ink keys, an ink tray roller, a ductor roller, and an ink transfer roller,
the method comprising the steps of:
(a) mounting an image-wise exposed printing plate material on the plate cylinder and
(b) carrying out a make-ready process for bringing the press to production quality which is defined by target color data on printed copies produced by the press, wherein said target color data are correlated to a standard ink supply as defined in standard printing conditions of the press, and
wherein said make-ready process comprises the steps of:
(b-i) starting a printing process by contacting the dampening system and the inking system with the plate material and feeding an ink receiving material through the press;
(b-ii) measuring color data on at least one of the printed copies and adjusting the inking system in accordance with the difference between the measured color data and the target color data; and
(b-iii) repeating step (b-ii) until the measured color data match the target color data,
characterized in that
(i) the printing plate material is developed on the press during step (b) and
(ii) the inking system in step (b-i) is configured to provide an actual ink supply which is different from the standard ink supply by a RIFT value of at least 10%, said RIFT value being defined by the following formula:
RIFT=absolute value of [(IB/IS)−1]*100,
wherein IB and IS are the ink film thickness on the ink transfer roller of said actual and standard ink supply respectively.

12. The method of claim 11, wherein IB>IS and the RIFT value is in the range from 30% to 250%.

13. The method of claim 11, wherein IB<IS and the RIFT value is in the range from 10% to 90%.

14. The method of claim 11, wherein step (b-ii) is carried out by an automatic press control system which enables to measure color data on at least one of the printed copies and to modify said color data on the printed copies by adjusting the inking system.

15. The method of claim 12, wherein step (b-ii) is carried out by an automatic press control system which enables to measure color data on at least one of the printed copies and to modify said color data on the printed copies by adjusting the inking system.

16. The method of claim 13, wherein step (b-ii) is carried out by an automatic press control system which enables to measure color data on at least one of the printed copies and to modify said color data on the printed copies by adjusting the inking system.

17. The method of claim 11, wherein the actual ink supply is made different from the standard ink supply by adjusting the contact between the ink tray roller and the ductor roller.

18. The method of claim 12, wherein the actual ink supply is made different from the standard ink supply by adjusting the contact between the ink tray roller and the ductor roller.

19. The method of claim 13, wherein the actual ink supply is made different from the standard ink supply by adjusting the contact between the ink tray roller and the ductor roller.

20. The method of claim 11, wherein the actual ink supply is made different from the standard ink supply by setting at least one of the ink keys to supply ink to an inking zone at a RIFT value of at least 10%.

21. The method of claim 12, wherein the actual ink supply is made different from the standard ink supply by setting at least one of the ink keys to supply ink to an inking zone at a RIFT value of at least 10%.

22. The method of claim 13, wherein the actual ink supply is made different from the standard ink supply by setting at least one of the ink keys to supply ink to an inking zone at a RIFT value of at least 10%.

23. The method of claim 11, wherein step (b-i) comprises a pre-dampening phase and a pre-inking phase.

24. The method of claim 12, wherein step (b-i) comprises a pre-dampening phase and a pre-inking phase.

25. The method of claim 13, wherein step (b-i) comprises a pre-dampening phase and a pre-inking phase.

26. The method of claim 11, wherein the printing plate precursor comprises a photopolymerizable or photocrosslinkable image recording layer.

27. The method of claim 26, wherein the printing plate precursor is exposed with infrared light.

28. The method of claim 11, wherein less than 150 copies are printed until completion of the make-ready process.

29. The method of claim 12, wherein less than 150 copies are printed until completion of the make-ready process.

30. The method of claim 13, wherein less than 150 copies are printed until completion of the make-ready process.
